(19) United States
(12) Patent Application Publication
(10) Pub. No.: US 2022/0147916 A1
(43) Pub. Date: May 12, 2022

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Jun USAMI, Toyota-shi (JP); Takaharu UENO, Nagoya-shi (JP); Shunsuke SAGARA, Nisshin-shi (JP); Lei WANG, Toyota-shi (JP); Shintaro MATSUTANI, Kariya-shi (JP); Kyoji IIJIMA, Toyota-shi (JP)

(73) Assignee: TOYOTA JIDOSHA KABUSHIKI KAISHA, Toyota-shi (JP)

(21) Appl. No.: 17/516,901

(22) Filed: Nov. 2, 2021

(30) Foreign Application Priority Data
Nov. 12, 2020 (JP) 2020-188461

(51) Int. Cl. G06Q 10/08; G06Q 30/06; G06Q 30/02

(52) U.S. Cl. CPC G06Q 10/0832; G06Q 10/0838; G06Q 30/0631; G06Q 30/0267; G06Q 30/0255; G06Q 30/0261; G06Q 30/0621

(57) ABSTRACT

An information processing apparatus disclosed has a controller. When it is determined that a user is at home, the controller obtains taste information relating to the taste of the user for food and drink. The controller selects a candidate item to be delivered on the basis of the obtained taste information. The candidate item to be delivered is a candidate of an item of food and drink to be delivered to the user's home. The controller executes specific processing relating to delivery of the selected candidate item to be delivered to the user's home.

### CROSS-REFERENCE TO RELATED APPLICATIONS

This application claims the benefit of Japanese Patent Application No. 2020-188461, filed on Nov. 12, 2020, which is hereby incorporated by reference herein in its entirety.

### BACKGROUND

### Technical Field

The present disclosure relates to a technology pertaining to delivery of food and drink.

### Description of the Related Art

There are known composite flyers (or handbills) having a first side on which a telephone number for taking orders and a two-dimensional code representing the URL of a web site for taking orders are printed and a second side on which information about food and drink provided by a plurality of catering service providers is printed (see, for example, Patent Literature 1 in the citation list below).

### CITATION LIST

### Patent Literature

Patent Literature 1: Japanese Patent Application Laid-Open NO. 2012-208355

### SUMMARY

An object of this disclosure is to provide a technology that can improve the convenience of users who enjoy food-and-drink delivery services.

Disclosed herein is an information processing apparatus. The information processing apparatus may comprise, for example, a controller including at least one processor, the controller being configured to execute the processing of:

determining whether or not a user is at home;

if it is determined that the user is at home, obtaining taste information relating to the taste of the user for food and drink;

selecting a candidate item to be delivered on the basis of the taste information, the candidate item to be delivered being a candidate of an item of food and drink to be delivered to the user's home; and

executing specific processing relating to delivery of the candidate item to be delivered to the user's home.

Also disclosed herein is an information processing method. The information processing method may comprise, for example, the following steps of processing executed by a computer:

determining whether or not a user is at home;

if it is determined that the user is at home, obtaining taste information relating to the taste of the user for food and drink;

selecting a candidate item to be delivered on the basis of the taste information, the candidate item to be delivered being a candidate of an item of food and drink to be delivered to the user's home; and

executing specific processing relating to delivery of the candidate item to be delivered to the user's home.

Also disclosed herein includes an information processing program configured to cause a computer to implement the above-described information processing method and a non-transitory storage medium in which this information processing program is stored.

This disclosure can provide a technology that can improve the convenience of users who enjoy food-and-drink delivery services.

### BRIEF DESCRIPTION OF DRAWINGS

FIG. 1 is a diagram illustrating the general configuration of a delivery system to which the technology disclosed herein is applied.

FIG. 2 is a block diagram illustrating exemplary components included in the delivery system.

FIG. 3 illustrates an example of information displayed on a user's terminal that has received offer information.

FIG. 4 illustrates an exemplary structure of a user information table.

FIG. 5 illustrates an exemplary structure of a store information table.

FIG. 6 is a flow chart of a process executed by a server apparatus.

FIG. 7 is a flow chart of specific processing according to an embodiment.

FIG. 8 is a flow chart of specific processing according to a first modification.

FIG. 9 is a flow chart of specific processing according to a second modification.

### DESCRIPTION OF EMBODIMENTS

The technology disclosed herein is characterized by selecting a candidate of an item of food and drink (e.g. a dish) to be delivered to the home of a user (which will also be referred to “candidate item to be delivered”) on the basis of the user's taste for food and drink and executing specific processing relating to delivery of the selected candidate item to be delivered. The term “food and drink” mentioned in this disclosure refers to food and drink suitable for a meal, which may be breakfast, lunch, or supper. The food and drink may be either food and drink that has already been cooked or prepared, or food and drink that can be cooked or prepared by a simple process, such as a process using a microwave oven.

A user may sometimes order delivery of food and drink when he or she does not have enough time to cook or go to buy food materials. This can be the case for example when he or she is working at his/her home. In such occasions, it can be troublesome for the user to search for a store (or a delivery service provider) having a delivery area that covers the user's home, check items of food and drink that the store can deliver, and place an order with the store. In such circumstances, improvement in the convenience of users in using food-and-drink delivery services is desired.

An information processing apparatus disclosed herein has a controller configured to determine whether or not a user is at home (namely, located at the location of the user's home). Specifically, the controller may compare the present location of a terminal carried by the user and the location of the user's home to determine whether or not the user is at home. Alternatively, the controller may check schedule information about the user to determine whether the user is at home. If a camera or a motion sensor is provided in the user's home, the controller may communicate with such a device to determine whether the user is at home.

If it is determined that the user is at home, the controller obtains information about the user's taste for food and drink. This information will be referred to as “taste information”. Specifically, the controller may obtain information about the categories of food and drink delivered to the user in the past as the taste information. The controller may obtain information about the price ranges of food and drink delivered to the user in the past as the taste information. The taste information is not limited to the information mentioned above, but it may be any kind of information by which the taste of the user who wants delivery of food and drink can be known.

After obtaining the taste information as above, the controller selects a candidate item to be delivered on the basis of the obtained taste information. In the case where the obtained taste information is information about the categories of food and drink delivered to the user in the past, the controller may select a candidate item to be delivered on the basis of the category of food and drink having the largest number of instances of delivery in the past. For example, the controller may select an item of food and drink that is different from or the same as the item of food and drink that was delivered to the user most recently from among the items belonging to the category of food and drink having the largest number of instances of delivery in the past as the candidate item to be delivered. The controller may select an item of food and drink that is served by a store different from or the same as the store that delivered something to the user most recently from among the items belonging to the category of food and drink having the largest number of instances of delivery in the past as the candidate item to be delivered. In the case where the obtained taste information is information about the price ranges of food and drink delivered to the user in the past, the controller may select a candidate item to be delivered on the basis of the price range having the largest number of instances of delivery in the past. For example, the controller may select an item of food and drink different from or the same as the item of food and drink that was delivered to the user most recently from among the items of food and drink that fall in the price range having the largest number of instances of delivery in the past as the candidate item to be delivered. The controller may select an item of food and drink that is served by a store different from or the same as the store that delivered something to the user most recently from among the items of food and drink that fall in the price range having the largest number of instances of delivery in the past as the candidate item to be delivered.

After selecting a candidate item to be delivered as above, the controller executes specific processing relating to delivery of the candidate item to be delivered to the user's home. This specific processing may include the processing of sending information for offering delivery of the candidate item to be delivered to the user's home to a user's terminal (which will also be referred to as “offer information” hereinafter) and, if receiving information indicating acceptance of the offer by the offer information from the user's terminal, the processing of placing an order with a store that serves the candidate item to be delivered for delivery of the candidate item to the user's home. The information indicating the acceptance of offer by the offer information will also be referred to as “acceptance information” hereinafter. The above processing enables the user to enjoy the food-and-drink delivery service without taking the trouble to search for a store having a delivery area that covers the user's home, check items of food and drink that the store can deliver, and place an order with the store.

The specific processing mentioned above may be the processing of placing an order with a store that serves the candidate item to be delivered for delivery of the candidate item to be delivered to the user's home. In other words, the specific processing may be the processing of automatically placing an order for the candidate item to be delivered. This enables the user to enjoy the food-and-drink delivery service automatically.

The specific processing may include the following three steps of processing. In the following description of the processing, the user to whom the candidate item is to be delivered will be referred to as “the target user”.

Processing 1: determining whether there is the home of another user (who will also be referred to as “reserve user”) for whom the candidate item to be delivered is equivalent to that for the target user within a specific distance from (or within a specific range about) the target user's home.

Processing 2: if there is the reserve user's home within the specific range, placing an order with a store that serves the candidate item to be delivered for delivery of the candidate item to the target user's home.

Processing 3: if the target user declines to receive the candidate item, requesting the store to deliver the candidate item to the reserve user's home.

Thus, in the case where an order for delivery of the candidate item to be delivered is placed automatically, even if the user declines to receive the candidate item, it can be delivered to the reserve user instead. This can reduce the possibility of loss incurred to the store. If there is no reserve user's home within the specific range, the controller may send the offer information to the user's terminal. Then, if the controller receives the acceptance information from the user's terminal, the controller may place an order with the store for delivery of the candidate item to be delivered to the user's home. This can reduce the possibility of loss incurred to the store, even in the case where there is no reserve user's home within the specific range. The specific distance mentioned above is a distance that is determined such that even if the delivery person delivers the candidate item to be delivered to the reserve user's home after going to the target user's home, the quality of the candidate item will not be deteriorated.

### EMBODIMENT

In the following, a specific embodiment of the technology disclosed herein will be described with reference to the drawings. It should be understood that the dimensions, materials, shapes, relative arrangements, and other features of the components that will be described in connection with the embodiment are not intended to limit the technical scope of this disclosure only to them, unless otherwise stated.

What will be described in the following as an embodiment is a case where the technology disclosed herein is applied to a system that provides the service of delivering food and drink to users who are at their homes. This system will also be referred to as “delivery system” hereinafter. The term “food and drink” used in connection with this embodiment refers to food and drink suitable for a meal, which may be breakfast, lunch, or supper, as described previously. The food and drink may be either one that has already been cooked or prepared, or one that can be cooked or prepared by a simple process, such as a process using a microwave oven.

### (General Configuration of Delivery System)

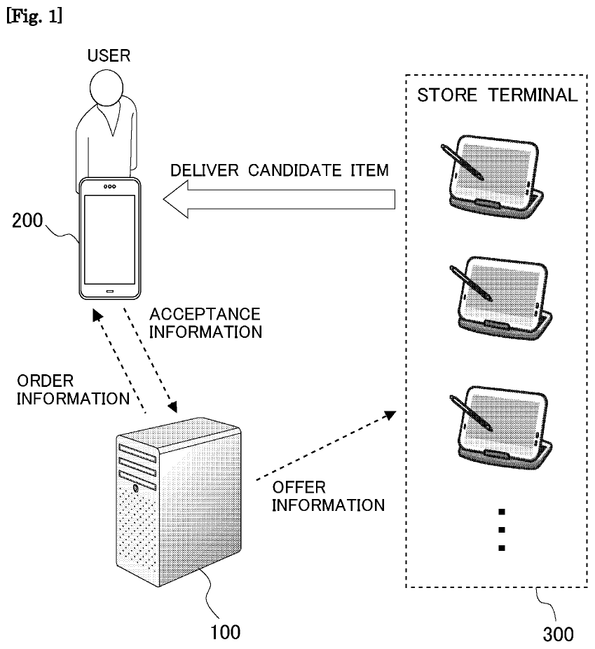

FIG. 1 is a diagram illustrating an exemplary configuration of the delivery system according to the embodiment. The delivery system according to the embodiment includes a server apparatus 100, a user's terminal 200, and store terminals 300. While FIG. 1 illustrates only one user's terminal 200, there may be a plurality of user's terminals 200 that are under the management of the delivery system.

The server apparatus 100 is an information processing apparatus that manages delivery of food and drink to users who are at their homes. The server apparatus 100 in the system according to the embodiment has the function of determining whether or not a user is at home, the function of selecting a candidate of an item of food and drink to be delivered to the user's home (i.e. a candidate item to be delivered), and the function of offering delivery of the candidate item to be delivered to the user. The server apparatus 100 also has the function of placing an order for the candidate item to be delivered, if the user accepts the above offer. The user's terminal 200 is a terminal carried by the user and has the function of communicating with the server apparatus 100. In the system according to the embodiment, the user's terminal 200 has the function of presenting information (or offer information) relating to the candidate item to be delivered offered by the server apparatus 100 to the user and the function of sending information indicating the acceptance of the offer presented by the offer information to the server apparatus 100. The latter information will also be referred to as “acceptance information” hereinafter. The user's terminal 200 also has the function of determining the present location of the user's terminal 200 and sending information about the present location thus determined to the server apparatus 200. The information about the present location of the user's terminal will also be referred to as “location information” hereinafter. The user's terminal 200 may execute the processing of determining the present location and sending the location information either repeatedly at predetermined intervals or in response to a request sent from the server apparatus 100. The store terminal 300 is a terminal provided in each of the stores (or delivery service providers) that are under the management of the delivery system. The store terminal 300 has the function of communicating with the server apparatus 100. The stores in which the store terminals 300 are provided are those which provide the service of delivering food and drink. The store terminal 300 used in the system according to the embodiment has the function of presenting order information sent from the server apparatus 100 to a clerk of the store.

The sever apparatus 100 in the delivery system determines whether or not a user is at his/her home. The server apparatus 100 in the system according to the embodiment assumes that the present location of the user's terminal 200 is the present location of the user and determines whether or not the user is at home by comparing the present location of the user's terminal 200 and the location of the user's home. The processing of this determination is executed, for example, a predetermined time (e.g. several tens of minutes to one hour) earlier than a typical meal time (e.g. the time slot from 6 to 9 o'clock, the time slot from 11 to 14 o'clock, or the time slot from 18 to 21 o'clock). The time at which the processing of this determination is executed will also be referred to as “determination time” hereinafter. If it is determined that the user is at home, the server apparatus 100 obtains information about the user's taste for food and drink. This information will also be referred to “taste information” hereinafter. The taste information is information about the user's taste for food and drink that can be provided by delivery services. The taste information used in the system according to the embodiment includes at least one of information about the categories of food and drink delivered to the user in the past and information about the price ranges of food and drink delivered to the user in the past. The server apparatus 100 selects a candidate item to be delivered on the basis of the obtained taste information. Then, the server apparatus 100 sends information (or offer information) for offering delivery of the candidate item thus selected to the user's home to the user's terminal 200. If the server apparatus 100 receives acceptance information sent from the user's terminal 200 in replay to the offer information, the server apparatus 100 sends information (or order information) for placing an order for delivery of the candidate item to be delivered to the user's home to the store terminal 300 of a store that serves the candidate item to be delivered. When the store terminal 300 receives the order information, the store terminal 300 presents the order information to a store clerk, so that the order for the candidate item to be delivered is received. Thus, the user at home can enjoy the food-and-drink delivery service without taking the trouble to search for a store having a delivery area that covers the user's home, check items of food and drink that the store can deliver, and place an order with the store. The server apparatus 100 may be configured not to send offer information to the user's terminal 200 of a user when the user is not at home.

### (System Configuration)

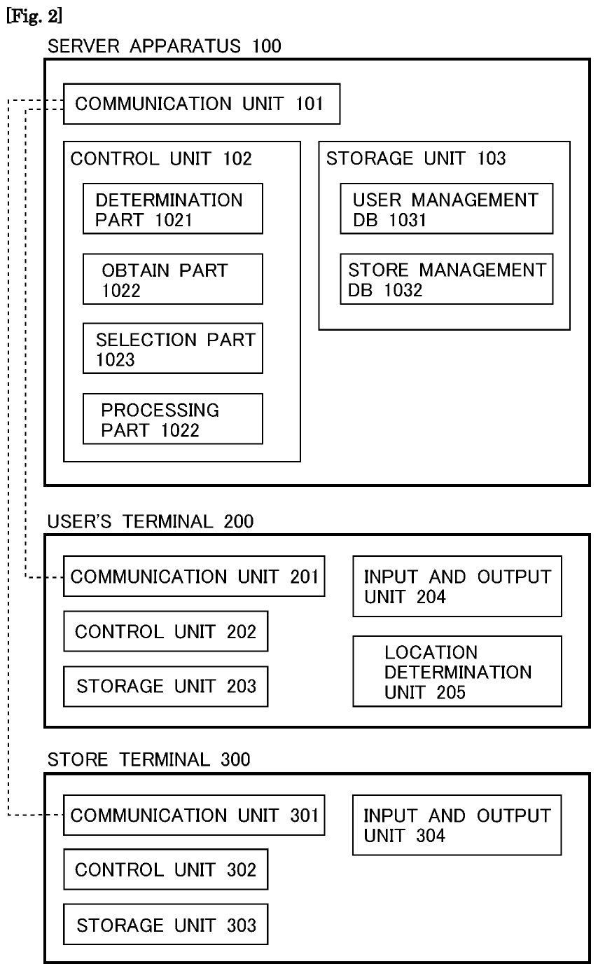

The configuration of the delivery system according to the embodiment will now be described with reference to FIG. 2. FIG. 2 is a block diagram illustrating exemplary configurations of the server apparatus 100, the user's terminal 200, and the store terminal 300 illustrated in FIG. 1.

(Server Apparatus 100)

As described above, the server apparatus 100 is an information processing apparatus that manages delivery of food and drink to users who are at their homes. The server apparatus 100 constitutes the information processing apparatus according to this disclosure. The server apparatus 100 may be constituted by a general-purpose computer. For example, the server apparatus 100 includes a processor, such as a CPU or a GPU, a main storage device, such as a RAM or a ROM, and an auxiliary storage device, such as an EPROM, a hard disk drive, or a removable medium. The removable medium may be a recording medium, such as a USB memory, a CD, or a DVD. The auxiliary storage device stores an operating system (OS), programs, and tables. The programs stored in the auxiliary storage device include a program for managing delivery of food and drink to users who are at their homes. The server apparatus 100 implements functions for achieving purposes that will be described later by executing a program(s) stored in the auxiliary storage device by the processor. Some or all of the functions of the server apparatus 100 may be implemented by a hardware circuit(s), such as an ASIC or an FPGA.

As illustrated in FIG. 2, the server apparatus 100 of this embodiment has a communication unit 101, a control unit 102, and a storage unit 103. The configuration of the server apparatus 100 is not limited to the configuration illustrated in FIG. 2, but some components may be eliminated, added, or replaced by other components fitly.

The communication unit 101 is a communication interface for connecting the server apparatus 100 to a network. For example, the communication unit 101 communicates with the user's terminal 200 and the store terminals 300 via the network using a communication network, such as LAN (Local Area Network), WAN (Wide Area Network), or Wi-Fi (registered trademark). The communication unit 101 may communicate with the user's terminal 200 and the store terminals 300 using a mobile communication service, such as 5G (5th Generation) mobile communications, or LTE (Long Term Evolution) mobile communications, or a wireless communication network, such as Wi-Fi.

The control unit 102 is constituted by a processor and performs overall control of the server apparatus 100. The control unit 102 of this embodiment has, as functional modules, a determination part 1021, an obtainment part 1022, a selection part 1023, and a processing part 1024. The control unit 102 implements these functional modules by executing a program stored in the auxiliary storage device by the processor.

The determination part 1021 determines whether or not the user is at home at the determination time mentioned above. Specifically, the determination part 1021 makes this determination by comparing the present location of the user's terminal 200 and the location of the user's home. If the present location of the user's terminal 200 and the location of the user's home coincide with each other, the determination part 1021 determines that the user is at home. If the present location of the user's terminal 200 and the location of the user's home do not coincide with each other, the determination part 1021 determines that the user is not at home (out from home). This processing of determination is executed based on information stored in the storage unit 103, which will be described later.

The determination part 1021 may determine whether or not the user is at home on the basis of schedule information about the user. If a schedule management application program is installed in the user's terminal 200, the determination part 1021 may obtain schedule information about the user by communicating with the user's terminal 200 through the communication unit 101.

If a camera or a motion sensor having a communication function is provided in the user's home, the determination part 1021 may determine whether or not the user is at home by communicating with the camera or the motion sensor.

If it is determined by the determination part 1021 that the user is at home, information indicating the result of determination (namely, information indicating that the user is at home) is passed from the determination part 1021 to the obtainment part 1022.

Triggered by reception of the information passed from the determination part 1021, the obtainment part 1022 obtains taste information about the user. For example, the obtainment part 1022 obtains information about the categories of food and drink delivered to the user in the past as the taste information. The obtainment part 1022 may obtain information about the price ranges of food and drink delivered to the user in the past as the taste information. Such taste information is obtained from data stored in the storage unit 103, which will be described later. The taste information is not limited to the aforementioned information about the categories of food and drink or information about the price ranges of food and drink, but it may be any kind of information by which the taste of the user for food and drink that can be delivered by delivery service can be known.

The taste information obtained by the obtainment part 1022 is passed from the obtainment part 1022 to the selection part 1023.

Triggered by reception of the information passed from the obtainment part 1022, the selection part 1023 selects a candidate item to be delivered. For example, the selection part 1023 may select a candidate item to be delivered on the basis of the category of food and drink having the largest number of instances of delivery in the past. Specifically, the selection part 1023 may select an item of food and drink that is different from or the same as the item of food and drink that was delivered to the user most recently from among the items belonging to the category of food and drink having the largest number of instances of delivery in the past as the candidate item to be delivered. Alternatively, the selection part 1023 may select an item of food and drink that is served by a store different from or the same as the store that delivered something to the user most recently from among the items belonging to the category of food and drink having the largest number of instances of delivery in the past as the candidate item to be delivered.

In the case where the taste information obtained by the obtainment part 1022 is information about the price ranges of food and drink delivered to the user in the past, the selection part 1023 may select a candidate item to be delivered on the basis of the price range having the largest number of instances of delivery in the past. For example, the selection part 1023 may select an item of food and drink different from or the same as the item of food and drink that was delivered to the user most recently from among the items of food and drink that fall in the price range having the largest number of instances of delivery in the past as the candidate item to be delivered. Alternatively, the selection part 1023 may select an item of food and drink that is served by a store different from or the same as the store that delivered something to the user most recently from among the items of food and drink that fall in the price range having the largest number of instances of delivery in the past as the candidate item to be delivered.

In the case where the taste information obtained by the obtainment part 1022 includes information about the categories of food and drink delivered to the user in the past and information about the price ranges of food and drink delivered to the user in the past, the selection part 1023 may select a candidate item to be delivered on the basis of these two kinds of information. For example, the selection part 1023 may select an item of food and drink that falls in the price range having the largest number of instances of delivery in the past from among the items belonging to the category of food and drink having the largest number of instances of delivery as the candidate item to be delivered.

The method of selecting a candidate item to be delivered is not limited to those described above, but it may be modified based on a record of operations of the delivery service or the user's satisfaction.

Information about the candidate item to be delivered selected by the selection part 1023 is passed from the selection part 1023 to the processing part 1024. The information passed from the selection part 1023 to the processing part 1024 includes information about the item name of the candidate item to be delivered, information about the price of the candidate item to be delivered, information about the name of a store that serves the candidate item to be delivered, and information about the location of the user's home.

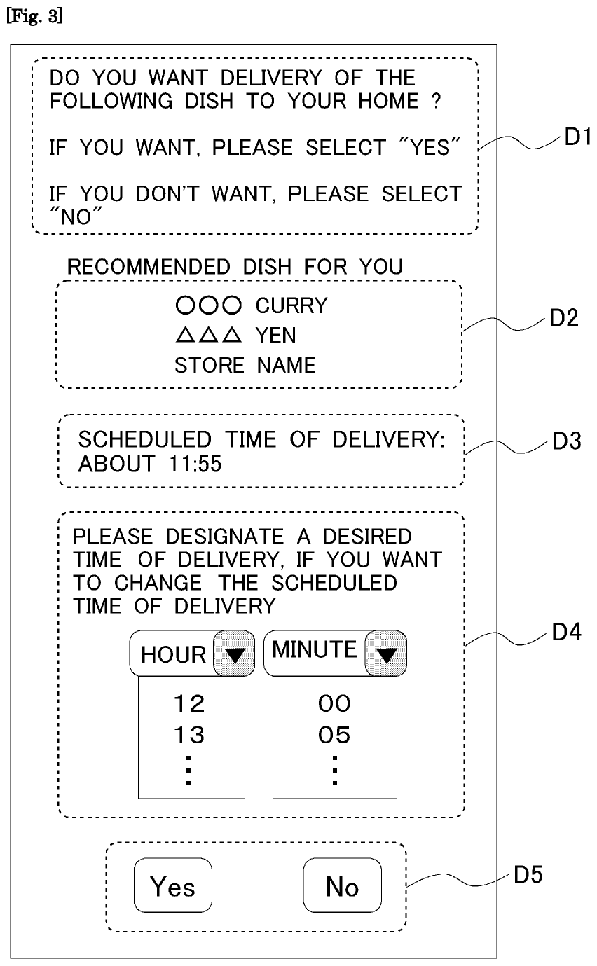

The processing part 1024 has the function of sending offer information to the user's terminal 200 and the function of placing an order for the candidate item to be delivered. Specifically, triggered by reception of the information passed from the selection part 1023, the processing part 1024 firstly generates offer information. The offer information is information for offering delivery of the candidate item to be delivered to the user's home. The offer information includes information for causing the user's terminal 200 to display a screen shown in FIG. 3. The screen shown in FIG. 3 includes the following five displayed divisions.

Division 1: a message asking whether the user wants delivery of the candidate item to be delivered (D1 in FIG. 3).

Division 2: information showing the name of the candidate item to be delivered, its price, and the name of the store that serves it (D2 in FIG. 3).

Division 3: information indicating the scheduled time of delivery (D3 in FIG. 3).

Division 4: a menu allowing the user to change the scheduled time of delivery (D4 in FIG. 3).

Division 5: buttons allowing the user to select acceptance or declination of the offer presented by the offer information (D5 in FIG. 3).

The offer information generated by the processing part 1024 is sent to the user's terminal 200 through the communication unit 101. The user's terminal 200 receives the offer information and displays a screen like that shown in FIG. 3, so that the user can see the name of the candidate item to be delivered, its price, the name of the store that serves it, and the scheduled time of delivery. If the user who sees the screen shown in FIG. 3 selects “Yes” on the screen, the user's terminal 200 sends acceptance information to the server apparatus 100. The acceptance information is information indicating the user's acceptance of the offer presented by offer information (namely delivery of the candidate item to be delivered to the user's home). In the case where the user changes the scheduled time of delivery on the screen shown in FIG. 3, the acceptance information contains information about the scheduled time of delivery after change. If the user who sees the screen shown in FIG. 3 selects “No” on the screen, the user's terminal 200 does not send acceptance information to the server apparatus 100. If the server apparatus 100 receives the acceptance information sent from the user's terminal 200, the processing part 1024 sends order information to the store terminal 300 of a store that serves the candidate item to be delivered. The order information contains information about the name of the candidate item to be delivered, information about the location of the user's home, and information about the scheduled time of delivery.

The storage unit 103 stores various information. The storage unit 103 is constituted by the main storage device and/or the auxiliary storage device. The storage unit 103 stores various programs executed by the processor and various data. In the storage unit 103 of this embodiment are constructed a user management database 1031 and a store management database 1032. The user management database 1031 and the store management database 1032 are constructed by managing data stored in the auxiliary storage device by a database management system program (DBMS program) executed by the processor. The user management database 1031 and the store management database 1032 may be constructed as relational databases.

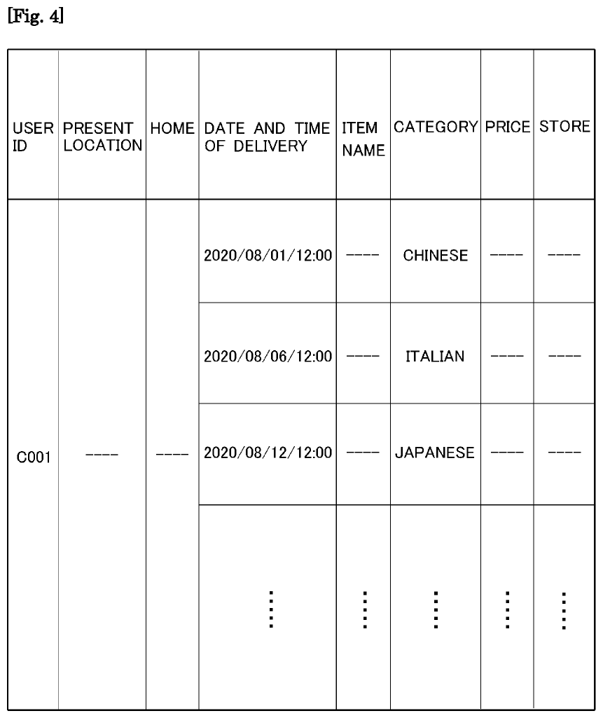

What is stored in the user management database 1031 is taste information of the users. The user management database 1031 links each user and the taste information of him/her. An exemplary structure of information stored in the user management database 1031 will be described here with reference to FIG. 4. FIG. 4 illustrates an exemplary table structure of information stored in the user management database 1031. The structure of tables stored in the user management database 1031 (which will also be referred to as “user information tables” hereinafter) is not limited to that illustrated in FIG. 4, but some fields may be added, changed, or removed. While FIG. 4 illustrates information table for one user, user information tables as many as the users who are under the management of the delivery system are stored in the user management database 1031.

As illustrated in FIG. 4, the user information table in the system according to the embodiment has the fields of user ID, present location, home, date and time of delivery, item name, category, price, and store. What is stored in the user ID field is information for identifying each of the users who are under the management of the delivery system. What is stored in the present location field is information indicating the present location of the user, such as information indicating the address of the present location or the coordinates of the present location on a map (e.g. latitude and longitude). In the system according to the embodiment, information indicating the present location of the user's terminal 200 is stored in the present location field. The information stored in the present location field is updated every time the communication unit 101 of the server apparatus 100 receives location information sent from the user's terminal 200. What is stored in the home field is information indicating the location of the user's home, such as information indicating the address of the user's home or the coordinates of the location of the user's home on a map (e.g. latitude and longitude). What is stored in the date and time of delivery field is information indicating the date and time when an item of food and drink was delivered to the user's home in the past. What is stored in the item name field is information about the name of the item of food and drink that was delivered to the user's home at each date and time of delivery in the past. What is stored in the category field is information about the category of the item delivered to the user's home at each date and time of delivery in the past. For example, if the item of food and drink that was delivered to the user's home in the past was a Chinese dish, the information “Chinese” is stored in the category field. If the item of food and drink that was delivered to the user's home in the past was an Italian dish, the information “Italian” is stored in the category field. If the item of food and drink that was delivered to the user's home in the past was a Japanese dish, the information “Japanese” is stored in the category field. What is stored in the price field is information indicating the price of the item of food and drink that was delivered to the user's home at each date and time of delivery in the past. What is stored in the store field is information about the name of the store that serves the item of food and drink delivered to the user's home at each date and time of delivery in the past. The fields of date and time, item name, category, price, and store are added every time the user receives an item of food and drink delivered by a store that is under the management of the delivery system.

The user information table as above may be created at the time when the user makes the first order for delivery with a store that is under the management of the delivery system or when the user subscribes to the delivery service.

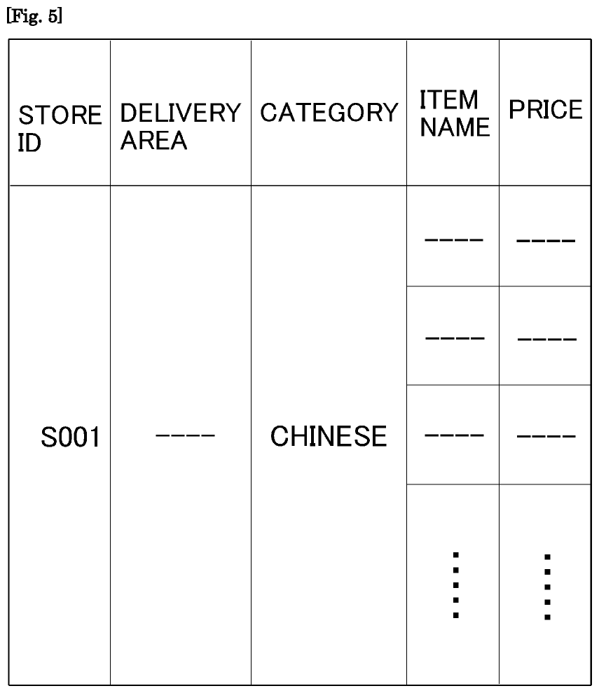

What is stored in the store management database 1032 is information relating to the stores that are under the management of the delivery system. The store management database 1032 links each of the stores and its attributes. An exemplary structure of information stored in the store management database 1032 will be described here with reference to FIG. 5. FIG. 5 illustrates an exemplary table structure of information stored in the store management database 1032. The structure of tables stored in the store management database 1032 (which will also be referred to as “store information tables” hereinafter) is not limited to that illustrated in FIG. 5, but some fields may be added, changed, or removed. While FIG. 5 illustrates information table for one store, store information tables as many as the stores that are under the management of the delivery system are stored in the store management database 1032.

The store information table illustrated in FIG. 5 has the fields of store ID, delivery area, category, item name, and price. What is stored in the store ID field is information for identifying each of the stores that are under the management of the delivery system. What is stored in the delivery area field is information indicating the delivery area of each store. The information stored in the delivery area field may be information about the addresses in the delivery area or information indicating the delivery area on a map. What is stored in the category field is information about the category of food and drink that each store serves. For example, in the case of a store that serves Chinese dishes, the information “Chinese” is stored in the category field. What is stored in the item name fields is information indicating the names of respective items of food and drink (or dishes) that each store serves. What is stored in the price field is information indicating the prices of the respective items of food and drinks that each store serves.

Various processing executed by the server apparatus 100 configured as above may be executed by either hardware or software.

(User's Terminal 200)

The user's terminal 200 will be described next. The user's terminal 200 is a computer used by the user. The user's terminal 200 is a terminal that the user can carry. Examples of the user's terminal include a smartphone, a cellular phone, a tablet computer, and a wearable computer (e.g. a smartwatch).

As illustrated in FIG. 2, the user's terminal 200 has a communication unit 201, a control unit 202, a storage unit 203, an input and output unit 204, and a location determination unit 205. The configuration of the user's terminal 200 is not limited to the configuration illustrated in FIG. 2, but some components may be eliminated, added, or replaced by other components fitly.

The communication unit 201 is a wireless communication interface for connecting the user's terminal 200 to a network. The communication unit 201 is connected to the network using a mobile communication service, such as 5G (5th Generation) mobile communications, or LTE (Long Term Evolution) mobile communications, or a wireless communication network, such as Wi-Fi (registered trademark) and communicates with the server apparatus 100 through the network.

The control unit 202 is constituted by, for example, a microcomputer and performs overall control of the user's terminal 200. The control unit 202 according to the embodiment has the function of causing the input and output unit 204 (which will be specifically described later) to display the aforementioned screen shown in FIG. 3, when the communication unit 201 receives offer information sent from the server apparatus 100. The control unit 202 also has the function of generating acceptance information and sending the acceptance information thus generated to the server apparatus 100 through the communication unit 201, when the user selects “Yes” on the screen shown in FIG. 3.

The storage unit 203 stores various information. The storage unit 203 may be constituted by a storage medium, such as a RAM, a magnetic disk, or a flash memory. The storage unit 203 stores various programs executed by the control unit 202 and various data.

The input and output unit 204 is configured to receive inputting operations conducted by the user and present information to the user. The input and output unit 204 includes, for example, a touch panel, a control circuit for the touch panel, a liquid crystal display, a control circuit for the liquid crystal display, a microphone, a control circuit for the microphone, a speaker, and a control circuit for the speaker. The touch panel and the liquid crystal display may be constituted by a single touch panel display. When the communication unit 201 receives the offer information sent from the server apparatus 100, the input and output unit 204 according to this embodiment causes the touch panel display to display the screen shown in FIG. 3. When the user selects “Yes” or “No” in the screen shown in FIG. 3 displayed on the touch panel display, the input and output unit 204 passes information about the result of selection to the control unit 202. If the user also conducts the operation of changing the scheduled time of delivery, the input and output unit 204 passes information about the scheduled time of delivery after change to the control unit 202 in addition to the aforementioned information about the result of selection.

The location determination unit 205 is a device for determining the location of the user's terminal 200 (namely, the location of the user). The location determination unit 205 typically includes a GPS (Global Positioning System) receiver. Information about the present location determined by the location determination unit 205 (which will also be referred to as “location information”) is sent to the server apparatus 100 through the communication unit 201.

Various processing executed by the user's terminal 200 configured as above may be executed by either hardware or software.

(Store Terminal 300)

The store terminal 300 is a computer provided in each of the stores that are under the management of the delivery system. The store terminal may be constituted by a general-purpose computer or a tablet computer.

As illustrate in FIG. 2, the store terminal 300 has a communication unit 301, a control unit 302, a storage unit 303, and an input and output unit 304. The configuration of the store terminal 300 is not limited to the configuration illustrated in FIG. 2, but some components may be eliminated, added, or replaced by other components fitly.

The communication unit 301, the storage unit 303, and the input and output unit 304 of the store terminal 300 are similar to the communication unit 201, the storage unit 203, and the input and output unit 204 of the user's terminal 200 and will not be described further. The control unit 302 is constituted by a processor or a microcomputer and performs overall control of the store terminal 300. When the communication unit 301 receives order information sent from the server apparatus 100, the control unit 302 according to the embodiment causes the input and output unit 304 to display details of an order. In doing so, the control unit 302 also causes the input and output unit 304 to output a certain alert tone to notify a store clerk of the reception of the order information.

Various processing executed by the store terminal 300 configured as above may be executed by either hardware or software.

### (Process Performed by Server Apparatus)

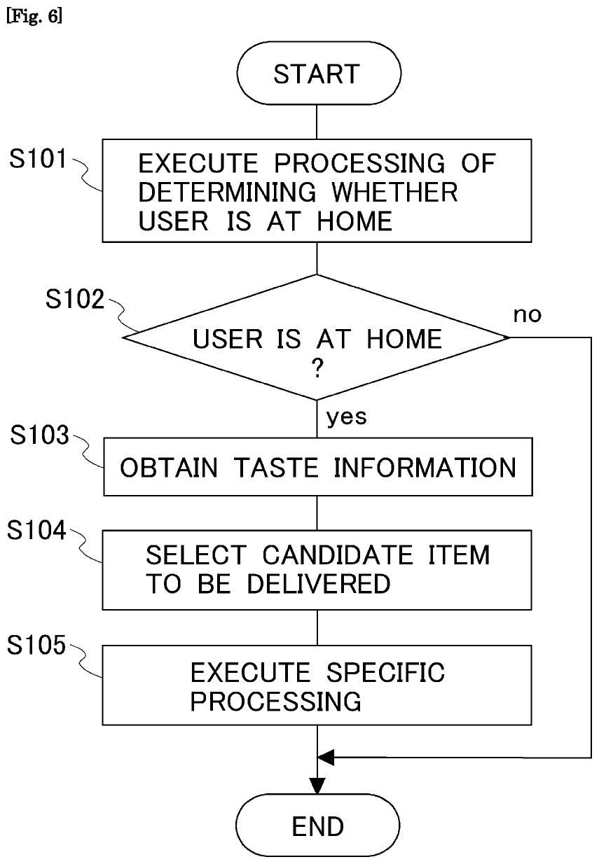

A process performed by the server apparatus 100 according to the embodiment will now be described with reference to FIG. 6. FIG. 6 is a flow chart of a process executed by the server apparatus 100 at the aforementioned determination time. The process according to the flow chart of FIG. 6 is executed for each of the users who are under the management of the delivery system.

In step S101 of the processing routine according to the flow chart of FIG. 6, the determination part 1021 of the server apparatus 100 executes the processing of determining whether the user is at home. Specifically, the determination part 1021 compares the present location of the user (namely, the present location of the user's terminal 200) and the location of the user's home. Information about the present location of the user and information about the location of the user's home are retrieved respectively from the present location field and the home field of the user information table associated with the user.

In step S102, it is determined whether or not the user is at home on the basis of the result of the above comparison in step S101. If the present location of the user and the location of the user's home coincide with each other, the determination part 1021 determines that the user is at home. If the present location of the user and the location of the user's home do not coincide with each other, the determination part 1021 determines that the user is not at home. If it is determined that the user is not at home (a negative answer in step S102), the process according to the flow chart of FIG. 6 is ended. If it is determined that the user is at home (an affirmative answer in step S102), the processing of step S103 is executed next.

In step S103, the obtainment part 1022 of the server apparatus 100 obtains taste information about the user. The taste information includes at least one of information about the categories of food and drink delivered to the user in the past and information about the price ranges of food and drink delivered to the user in the past. In the system according to the embodiment, the obtainment part 1022 obtains the user information table associated with the user as the taste information. The user information table obtained by the obtainment part 1022 is passed from the obtainment part 1022 to the selection part 1023.

In step S104, the selection part 1023 selects a candidate item to be delivered to the user on the basis of the information passed from the obtainment part 1022. For example, the selection part 1023 counts the number of past instances of delivery of items to the user belonging to each of the categories on the basis of the information stored in the category field of the user information table. Then, the selection part 1023 compares the numbers of instances of delivery in the respective categories to determine the category having the largest number of instances of delivery. Moreover, the selection part 1023 counts the number of past instances of delivery to the user of which the prices fall within each of a plurality of price ranges on the basis of the information stored in the category field of the user information table. Then, the selection part 1023 compares the numbers of instances of delivery in the respective price ranges to determine the price range having the largest number of instances of delivery. After determining the category having the largest number of instances of delivery and the price range having the largest number of instances of delivery, the selection part 1023 refers to the store information table stored in the store management database 1032 to pick up an item name of food and drink belonging to the category having the largest number of instances of delivery and the price range having the largest number of instances of delivery from among the items of food and drink served by the stores that are under the management of the delivery system. Then, the selection part 1023 picks up a store having a delivery area that covers the user's home from among the stores that serve an item of food and drink having the picked-up item name. This processing of picking up a store is executed based on information about the location of the user's home and the information stored in the delivery area field of the store information tables of the respective stores. Thus, the selection part 1023 selects the item of food and drink having the picked-up item name served by the picked-up store as the candidate item to be delivered. As described previously, the candidate item to be delivered may be selected based on only one of the category having the largest number of instances of delivery and the price range having the largest number of instances of delivery. The determination part 1023 passes information about the candidate item to be delivered selected by the selection part 1023 (e.g. information about its item name and price) and information about the store that serves the candidate item to be delivered (e.g. the name of the store) to the processing part 1024.

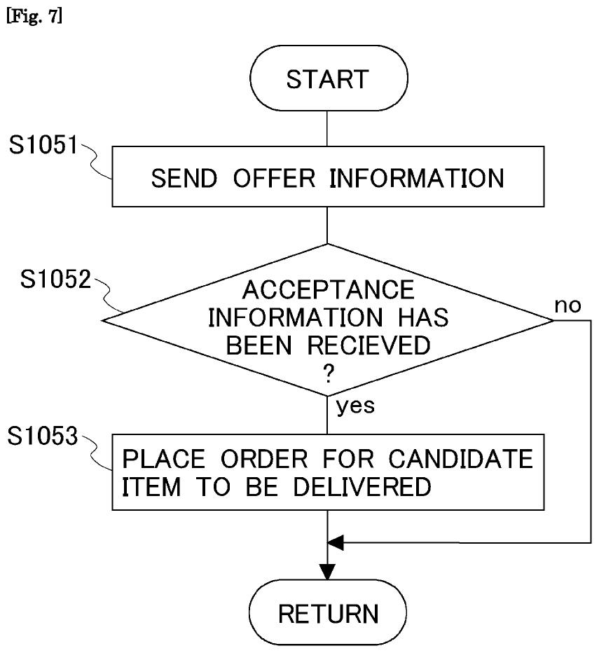

In step S105, the processing part 1024 executes specific processing relating to delivery of the candidate item to be delivered selected in step S104. The specific processing according to the embodiment will be described in the following with reference to FIG. 7. FIG. 7 is a flow chart of the process that is executed by the server apparatus 100 in executing the specific processing according to the embodiment.

In step S1051 in the process according to the flow chart of FIG. 7, the processing part 1024 sends offer information to the user's terminal 200 through the communication unit 101. The offer information is information for offering delivery of the candidate item to be delivered to the user's home. The offer information contains information for causing the user's terminal 200 to display the screen shown in FIG. 3. When the user's terminal 200 receives the offer information, the control unit 202 of the user's terminal 200 causes the input and output unit 204 to output (or display) the screen shown in FIG. 3. If the user selects “Yes” on the screen shown in FIG. 3, the control unit 202 generates acceptance information. If the user conducts the operation of changing the scheduled time of delivery on the screen shown in FIG. 3, the control unit 202 adds information about the scheduled time of delivery after change to the acceptance information. The control unit 202 sends the acceptance information thus generated to the server apparatus 100 through the communication unit 201. In the case where the user selects “No” on the screen shown in FIG. 3, the control unit 202 does not generate acceptance information, and acceptance information is not sent from the user's terminal 200 to the server apparatus 100.

In step S1052, the processing part 1024 determines whether or not the communication unit 101 has received acceptance information sent from the user's terminal 200. Even if the user intends to accept the offer presented by the offer information, acceptance information is not always sent immediately in response to the offer information. In step S1052, therefore, the processing part 1024 may determine whether the communication unit 101 receives acceptance information from the user's terminal 200 within a predetermined time (e.g. several to several tens of minutes) after sending the offer information. If the communication unit 101 does not receive acceptance information from the user's terminal 200 within the predetermined time after sending the offer information (a negative answer in step S1052), the process according to the flow chart of FIG. 7 is ended. If the communication unit 101 receives acceptance information from the user's terminal 200 within the predetermined time after sending the offer information (an affirmative answer in step S1052), the processing of step S1053 is executed next.

In step S1053, the processing part 1024 executes the processing of placing an order for delivery of the candidate item to be delivered. Specifically, the processing part 1024 sends order information to the store terminal 300 of the store picked up in step S104 in FIG. 6. The order information is information for placing an order for delivery of the candidate item to be delivered to the user's home. The offer information contains information about the item name of the candidate item to be delivered, information about the location of the user's home, and information about the scheduled time of delivery. When the store terminal 300 receives the offer information, the control unit 302 of the store terminal 300 causes the input and output unit 304 to display details of the order (i.e. the item name of the candidate item to be delivered, the location of the user's home, and the scheduled time of delivery etc.) and output a certain alert tone. Thus, a clerk of the store will see the information displayed by the input and output unit 304 to accept the order for the candidate item to be delivered.

The above-described delivery system according to the embodiment enables a user at home to enjoy the food-and-drink delivery service without taking the trouble to search for a store having a delivery area that covers the user's home, check items of food and drink that the store can deliver, and place an order with the store. The delivery system may be configured not to send offer information to the user's terminal 200 of a user while the user is not at home. In consequence, the delivery system can improve the convenience of users when they enjoy the food-and-drink delivery service.

### <First Modification>

The above-described delivery system according to the embodiment is configured to place an order for delivery of a candidate item to be delivered on condition that the user accepts offer information. Described in the following as a first modification of the embodiment is a delivery system configured to place an order for a candidate item to be delivered automatically.

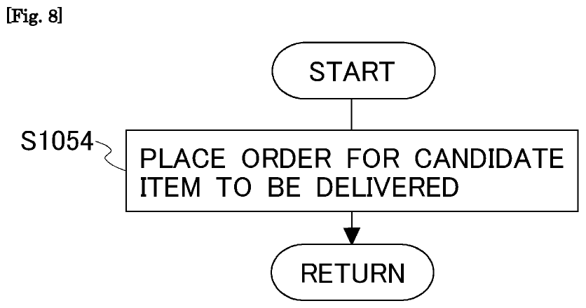

FIG. 8 is a flow chart of a process performed by the server apparatus 100 in executing specific processing according to the first modification.

In step S1054 of the process according to the flow chart of FIG. 8, the processing part 1024 places an order for the candidate item to be delivered. Specifically, the processing part 1024 sends order information to the store terminal 300 of the store picked up in step S104 in FIG. 6.

The specific processing according to the flow chart of FIG. 8 enables the user to receive an item of food and drink that matches the user's taste automatically without taking trouble to check offer information and send acceptance information. The specific processing according to the first modification is not executed while the user is not at home. This can prevent the candidate item to be delivered from being delivered automatically to the user's home where the user is absent.

### <Second Modification>

The delivery system according to the first modification is configured to place an order for the candidate item to be delivered automatically when the user is at home. Described in the following as a second modification of the embodiment is a delivery system configured to place an order for a candidate item to be delivered automatically when the user is at home only in the case where a certain condition is met.

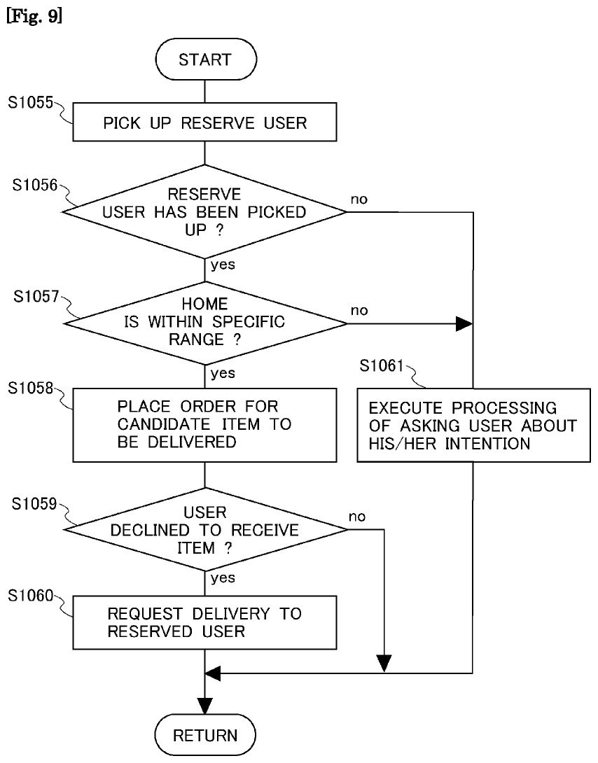

FIG. 9 is a flow chart of a process performed by the server apparatus 100 to execute specific processing according to the second modification.

In step S1055 of the process according to the flow chart of FIG. 9, the processing part 1024 picks up a reserve user. The reserve user is a user for whom the candidate item to be delivered selected by the process same as that for the target user is equivalent to the candidate item to be delivered for the target user. That the candidate item to be delivered for the reserve user is equivalent to the candidate item to be delivered for the target user may be construed that the item name of the candidate item to be delivered and the store that serves it are the same between both the users, that the item name of the candidate item to be delivered is the same between both the users, or that the category and the price range of the candidate item to be delivered are the same between both the users.

In step S1056, the processing part 1024 determines whether or not a reserve user was picked up in the above step S1055. If a reserve user was not picked up in step S1055 (a negative answer in step S1056), the processing part 1024 executes the processing of step S1061. In step S1061, the processing part 1024 executes the processing of asking the user about his/her intention. The processing of asking the user about his/her intention is a process performed in the same manner as in the above-described embodiment (namely, the process same as the process according to the flow chart of FIG. 7). If a reserve user was picked up in the above step S1055 (an affirmative answer in step S1056), the processing part 1024 executes the processing of step S1057.

In step S1057, the processing part 1024 determines whether or not the home of the reserve user is located within a specific range. The specific range is a range within a specific distance from the home of the target user. The specific distance mentioned above is a distance that is determined such that even if the delivery person delivers the candidate item to be delivered to the reserve user's home after going to the target user's home, the quality of the candidate item will not be deteriorated. If the home of the reserve user is not located within the specific range (a negative answer in step S1057), the processing part 1024 executes the processing of step S1061. If the home of the reserve user is located within the specific range (an affirmative answer in step S1057), the processing part executes the processing of step S1058.

In step S1058, the processing part 1024 sends order information to the store terminal 300 of the store picked up in step S104 in FIG. 6. Consequently, the candidate item to be delivered will be delivered to the home of the target user automatically. Then, the target user may decline to receive the candidate item to be delivered. If this occurs, information indicating that the target user declined to receive the candidate item to be delivered is sent from the store terminal 300 of the store that has received the order for the candidate item to be delivered to the server apparatus 100.

In step S1059, the processing part 1024 determines whether or not the communication unit 101 has received the information indicating that the target user declined to receive the candidate item to be delivered. In other words, the processing part 1024 determines whether or not the target user declined to receive the candidate item to be delivered. If the target user did not decline to receive the candidate item to be delivered (a negative answer in step S1059), the process according to the flow chart of FIG. 9 is ended. If the target user declined to receive the candidate item to be delivered (an affirmative answer in step S1059), the processing part 1024 executes the processing of step S1060.

In step S1060, the processing part 1024 sends information for requesting delivery of the candidate item to be delivered to the home of the reserve user to the store terminal 300 of the aforementioned store. This information contains information indicating the location of the home of the reserve user. Consequently, the delivery person of this store can deliver the candidate item to be delivered that was declined to receive by the target user to the home of the reserve user.

The delivery system according to the second modification places an order for the candidate item to be delivered automatically only in the case where a specific condition (i.e. the condition that there is the home of the reserve user within the specific range) is met, even when the target user is at home. In consequence, even if the target user declines to receive the candidate item to be delivered, it is possible to deliver it to the home of the reserve user. This can reduce the possibility of loss incurred to the store. In the case where the specific condition is not met, the delivery system places an order for the candidate item to be delivered after acquiring the target user's consent. This can also reduce the possibility of loss incurred to the store. Thus, the delivery system can improve the convenience of the user while ensuring a profit of the store.

The delivery system may be configured to place an order for the candidate item to be delivered automatically on condition that the target user is at home and that there are two or more reserve users whose home are located within the specific range. Even if the reserve user next to the target user in the order of delivery declines to receive the candidate item to be delivered, it is possible to deliver it to the home of another reserve user. This can reduce the possibility of loss incurred to the store with improved reliability.

### <Others>

The above embodiment and modifications have been described only by way of example. Modifications can be made to them without departing from the essence of this disclosure. Processing and features that have been described in this disclosure may be employed in any combination so long as it is technically feasible to do so. One, some, or all of the processes that have been described as processes performed by one apparatus may be performed by a plurality of apparatuses in a distributed manner. One, some, or all of the processes that have been described as processes performed by different apparatuses may be performed by a single apparatus. The hardware configuration employed to implement various functions in a computer system may be modified flexibly.

The technology disclosed herein can be carried out by supplying a computer program(s) (i.e. information processing program) that implements the functions described in the above description of the embodiment to a computer to cause one or more processors of the computer to read and execute the program(s). Such a computer program(s) may be supplied to the computer by a computer-readable, non-transitory storage medium that can be connected to a system bus of the computer, or through a network. The computer-readable, non-transitory storage medium refers to a recording medium that can store information, such as data and programs, electrically, magnetically, optically, mechanically, or chemically in such a way as to allow the computer or the like to read the stored information. Examples of such a non-transitory, computer-readable recording medium include any type of discs including magnetic discs, such as a floppy disc (registered trademark) and a hard disk drive (HDD), and optical discs, such as a CD-ROM, a DVD, and a Blu-ray disc. The computer-readable, non-transitory storage medium may include other storage media, such as a read-only memory (ROM), a random access memory (RAM), an EPROM, an EEPROM, a magnetic card, a flash memory, an optical card, and a solid state drive (SSD).

What is claimed is:

1. An information processing apparatus comprising a controller including at least one processor, the controller being configured to execute the processing of:
determining whether or not a user is at home;
if it is determined that the user is at home, obtaining taste information relating to the taste of the user for food and drink;
selecting a candidate item to be delivered on the basis of the taste information, the candidate item to be delivered being a candidate of an item of food and drink to be delivered to the user's home; and
executing specific processing relating to delivery of the candidate item to be delivered to the user's home.

2. The information processing apparatus according to claim 1, wherein the controller determines whether or not the user is at home on the basis of the present location of the user and the location of the user's home.

3. The information processing apparatus according to claim 1, wherein the controller determines whether or not the user is at home on the basis of schedule information about the user.

4. The information processing apparatus according to claim 1, wherein the controller obtains information about the categories of food and drink delivered to the user in the past as the taste information and selects the candidate item to be delivered on the basis of the category of food and drink having the largest number of instances of delivery in the past among the categories of food and drink delivered to the user in the past.

5. The information processing apparatus according to claim 1, wherein the controller obtains information about the price ranges of food and drink delivered to the user in the past as the taste information and selects the candidate item to be delivered on the basis of the price range of food and drink having the largest number of instances of delivery in the past among the price ranges of food and drink delivered to the user in the past.

6. The information processing apparatus according to claim 1, wherein the controller executes the following processing as the specific processing:
sending offer information for offering delivery of the candidate item to be delivered to the user's home to a terminal of the user; and
if the controller receives information indicating acceptance of the offer information from the terminal of the user, placing an order with a store that serves the candidate item to be delivered for delivery of the candidate item to be delivered to the user's home.

7. The information processing apparatus according to claim 1, wherein the controller executes the processing of placing an order with a store that serves the candidate item to be delivered for delivery of the candidate item to be delivered to the user's home as the specific processing.

8. The information processing apparatus according to claim 1, wherein the controller executes the following processing as the specific processing:
determining whether there is a home of a second user for whom the candidate item to be delivered is equivalent to that for the user within a specific distance from the user's home;
if there is the home of the second user within the specific distance from the user's home, placing an order with a store that serves the candidate item to be delivered for delivery of the candidate item to be delivered to the user's home; and
if the user declines to receive the candidate item to be delivered, requesting the store for delivery of the candidate item to be delivered to the home of the second user.

9. The information processing apparatus according to claim 8, wherein if there is not the home of the second user within the specific distance from the user's home, the controller executes the processing of:
sending offer information for offering delivery of the candidate item to be delivered to the user's home to a terminal of the user; and
if the controller receives information indicating acceptance of the offer information from the terminal of the user, placing an order with the store for delivery of the candidate item to be delivered to the user's home.

10. An information processing method comprising the following steps of processing executed by a computer:
determining whether or not a user is at home;
if it is determined that the user is at home, obtaining taste information relating to the taste of the user for food and drink;
selecting a candidate item to be delivered on the basis of the taste information, the candidate item to be delivered being a candidate of an item of food and drink to be delivered to the user's home; and
executing specific processing relating to delivery of the candidate item to be delivered to the user's home.

11. The information processing method according to claim 10, wherein the computer determines whether or not the user is at home on the basis of the present location of the user and the location of the user's home.

12. The information processing method according to claim 10, wherein the computer determines whether or not the user is at home on the basis of schedule information about the user.

13. The information processing method according to claim 10, wherein the computer obtains information about the categories of food and drink delivered to the user in the past as the taste information and selects the candidate item to be delivered on the basis of the category of food and drink having the largest number of instances of delivery among the categories of food and drink delivered to the user in the past.

14. The information processing method according to claim 10, wherein the computer obtains information about the price ranges of food and drink delivered to the user in the past as the taste information and selects the candidate item to be delivered on the basis of the price range of food and drink having the largest number of instances of delivery in the past among the price ranges of food and drink delivered to the user in the past.

15. The information processing method according to claim 10, wherein the computer executes the following processing as the specific processing:
sending offer information for offering delivery of the candidate item to be delivered to the user's home to a terminal of the user; and
if the controller receives information indicating acceptance of the offer information from the terminal of the user, placing an order with a store that serves the candidate item to be delivered for delivery of the candidate item to be delivered to the user's home.

16. The information processing method according to claim 10, wherein the computer executes the processing of placing an order with a store that serves the candidate item to be delivered for delivery of the candidate item to be delivered to the user's home as the specific processing.

17. The information processing method according to claim 10, wherein the computer executes the following processing as the specific processing:
determining whether there is a home of a second user for whom the candidate item to be delivered is equivalent to that for the user within a specific distance from the user's home;
if there is the home of the second user within the specific distance from the user's home, placing an order with a store that serves the candidate item to be delivered for delivery of the candidate item to be delivered to the user's home; and
if the user declines to receive the candidate item to be delivered, requesting the store for delivery of the candidate item to be delivered to the home of the second user.

18. The information processing method according to claim 17, wherein if there is not the home of the second user within the specific distance from the user's home, the controller executes the processing of:
sending offer information for offering delivery of the candidate item to be delivered to the user's home to a terminal of the user; and
if the controller receives information indicating acceptance of the offer information from the terminal of the user, placing an order with the store for delivery of the candidate item to be delivered to the user's home.

19. A non-transitory storage medium storing an information processing program configured to cause a computer to execute the following steps of processing:
determining whether or not a user is at home;
if it is determined that the user is at home, obtaining taste information relating to the taste of the user for food and drink;
selecting a candidate item to be delivered on the basis of the taste information, the candidate item to be delivered being a candidate of an item of food and drink to be delivered to the user's home; and
executing specific processing relating to delivery of the candidate item to be delivered to the user's home.

20. The non-transitory storage medium according to claim 19, wherein the information processing program causes the computer to execute the following processing as the specific processing:
determining whether there is a home of a second user for whom the candidate item to be delivered is equivalent to that for the user within a specific distance from the user's home;
if there is the home of the second user within the specific distance from the user's home, placing an order with a store that serves the candidate item to be delivered for delivery of the candidate item to be delivered to the user's home; and
if the user declines to receive the candidate item to be delivered, requesting the store for delivery of the candidate item to be delivered to the home of the second user.
